(19) United States
(12) Patent Application Publication
(10) Pub. No.: US 2021/0052053 A1
(43) Pub. Date: Feb. 25, 2021

(54) COVER FOR A MOBILE DEVICE WITH A SCREEN AND A CASE HAVING SUCH A COVER

(71) Applicant: TECH 21 LICENSING LIMITED, Middlesex (GB)

(72) Inventors: Jason ROBERTS, Middlesex (GB); Benjamin THORPE, Middlesex (GB); Thomas HOWARD, Middlesex (GB); Daniel CANE, Middlesex (GB)

(21) Appl. No.: 16/931,764

(22) Filed: Jul. 17, 2020

(30) Foreign Application Priority Data
Jul. 17, 2019 (GB) 1910212.8

(51) Int. Cl. A45C 11/00; G06F 1/16

(52) U.S. Cl. CPC A45C 11/00; G06F 1/1626; A45C 2011/002; A45C 2011/003; A45C 2200/15

(57) ABSTRACT

A cover for a mobile device with a screen includes the cover being configured to be pivotally connected a first edge 22 to a body 1 of a case having a generally rectangular shape and configured to receive the mobile device. The cover has a second free edge 19 opposite to the first edge, the cover being positioned in a closed position in which it substantially overlies the body to cover the device. An inner face faces the body in the closed position and an outer face is opposite to inner face. An inner layer 10 of a first generally rigid material is provided towards the inner face and an there is an outer layer 11 of an elastic material. The cover has a fold line 13 parallel to the first and second edges and closer to the first edge than the second edge, the cover being foldable about the fold line so as to be manipulatable into a number of configurations. A slit 14 being formed in the inner layer in the vicinity of the fold line, the inner and outer layer being detached from one another in the vicinity of the slit so as to form a pocket 15,16 positioned on one side of the slit and between the inner and outer layers.

### FIELD OF THE INVENTION

The present invention relates to a cover for a mobile device with a screen and a case with such a cover.

The present invention has been designed as a cover and a case for a tablet device. It could also be used in other devices such as smartphones, e-readers and laptops, but is mostly used for larger devices.

### BACKGROUND OF THE INVENTION

There are many cases for tablets which have a body having a generally rectangular shape configured to receive the mobile device. The cover is pivotally connected at a first edge to the body so that it can selectively cover the screen of the device received in the body. The cover is provided with one or more fold lines such that it can fold into a number of configurations in order to support the mobile device in a number of positions in use.

It is known, particularly in the field of smartphones, but also in some tablet cases to provide a number of slots on the inner face of the cover in order to receive one or more flat items such as credit cards and the like. The storage space is very limited and items stored in this way can press directly on the screen.

Tablet users will regularly carry a number of accessories such as charging leads, earphones and, in a more recent development, an electronic pencil or stylus. Some cases have been designed to store pencils, but this is usually done using a slot or loop adjacent to the tablet which creates a bulky case or leaves the pencil vulnerable to damage.

### SUMMARY OF THE INVENTION

The present invention aims at improving such prior art cases.

According to the present invention, there is provided a cover according to claim 1.

The cover may be sold as a separate item, or may be sold as a case which further comprises a body having a generally rectangular shape and configured to receive the mobile device, while the cover being pivotally connected at a first edge to the body.

The present invention provides storage within the cover which has a much higher capacity than that of the prior art. In particular, the cover is able to store larger items as these are retained between the generally rigid inner layer and the outer layer of elastic material. The majority of any bulging caused by the storage of an item with the cover is taken up by the elastic material such that the cover generally does not bulge towards the screen. This still allows the cover to be fully closed even when items are stored in the cover thereby reducing the tendency to force the cover into a partially opened position and relieving any pressure on the screen.

Because of the elastic material which is used to form the pocket, if a user decides not to store an item in one more of the pockets, that pocket effectively ‘disappears’ as the elastic material of the outer layer will lie flat against the inner layer. By contrast, if a feature such as a slot for an electronic pen is provided, this increases the bulk of the case even when no item is stored.

Further, because the slit is in the inner layer, when items are stored in the cover and the cover is closed, they are held securely because the slit in the cover is on the inside face of the cover.

When the case is folded into various configurations in order to create a stand, the inner layer of generally rigid material forms the outer face of the cover in these configurations so that the mobile device can be stably supported. At this time, the items can still be stored within the pocket as the elastic material deforms into the space between the cover and the back of the body.

There may be a single pocket. However, preferably, a second pocket is positioned on the opposite side of the slit between the inner and outer layers.

The position of the slit in the vicinity of the fold line which is closer to the first edge than the second edge results in the formation of pockets of different sizes. The first pocket closest to the first edge is narrower than the second pocket and is ideal for storage of a device such as an electronic pencil. The second pocket is wider and is ideal for storing less elongate items such as earphones (wired or wireless), charging cables or even a smartphone (when the case is large enough to accommodate a tablet).

The inner and outer layers may be detached from one another across the full surface area of the cover, only being joined at peripheral edges. This maximises the size of the pockets. The layers are joined on the most outer edges of the case There is also stitching between layers which forms the boundary of the pocket.

The outer layer may be made of a single elastic material. Alternatively, it may just have the elastic material in the centre of the case, surrounded by a more rigid material. The elastic material is preferably a woven fabric with elastic fibres.

The cover may optionally have a closure mechanism. This may be a conventional closure mechanism such as a stud which engages with a corresponding feature on the rear of the body, or a magnetic closure mechanism. However, preferably, a layer of elastic material extends across the corners of the inner layer adjacent to the second edge so as to form corner pockets positioned, in use, to engage with corresponding corners of the body to hold the cover in the closed position.

These elasticated corner pockets provide a simple, yet firm and a secure closure mechanism which provides additional protection for the corners of the device when closed. This removes the need for a physical mechanism or magnetic closure which is both costly and more complicated to produce.

In the closed position, the corner pockets extend across the rear face of the corners of the body. Most tablets have a camera in this region and, in general, the body of the case has apertures in order to allow the camera to continue to function whilst in the in the case. In the present case, in the closed configuration, the camera can be covered thereby protecting the lens from dirt and damage.

The nature of the elasticated material means that, when the cover is opened, the resilience of the material will cause them to lie relatively flat against the inner face of the cover so that they are not intrusive in this position. The layer of elastic material may be a continuation of the layer of elastic material on the outer layer of the cover or may be a separate material.

The elastic material may be confined only to the corners of the second edge of the cover. However, preferably, the layer of elastic material extends fully across the second edge.

This improves the closure of the cover and fully protects the adjacent edge of the device. The iPad is designed to have a magnetic attachment for an electronic pencil at one edge. This elastic material can be sufficiently elastic to cover the electronic pencil held in this position. This will prevent it from being dislodged and protect it when not in use. In this case, the layer of elastic material may have a uniform width but is preferably wider in the vicinity of the corners than it is in the area between the corners.

This closure mechanism formed a second aspect of the invention as defined in claim 6.

When the invention relates to a case with a body, rather than the cover alone, a handle may be formed of a flat strip of material retained at either end in slots in a rear face of the body opposite to and facing away from the cover, the handle being movable for a stowed position in which it lies flat against the rear face of the body to a deployed position in which its ends are moved closer together such that it takes up a bowed configuration providing a usable handle, the second edge of the cover having a projection to engage, in use, with handle in the deployed position.

It is known to provide cases for tablets which have a handle on a rear face, but these are not retractable in the manner claimed and are therefore obtrusive when not in use. Further, they are not positioned as to engage with an edge of the cover so are incapable of providing this additional functionality.

This provides a third aspect of the present invention which is defined in claim 11.

Whilst the invention can be applied to smaller devices such as smartphones, it is particularly applicable to tablet devices. Preferably, therefore, the cover has a length of greater than 19 cm and a width of greater than 13 cm. More preferably the cover has a length of greater than 23 cm and a width of greater than 16 cm.

### BRIEF DESCRIPTION OF THE DRAWINGS

An example of a cover and a case in accordance with the present invention will now be described with reference to the accompanying drawings, in which:

FIG. 1 is a schematic cross section through the case in a closed configuration;

FIG. 2 is a view similar to FIG. 1 in an opened configuration;

FIG. 3 is a view similar to FIG. 2 seen in the opposite direction of the case in a first folded configuration;

FIG. 4 is a view similar to FIG. 1 of the case in a second folded configuration;

FIG. 5 is a perspective view of the case with a mobile device in place in a position similar to that of FIG. 2;

FIG. 6 is a view similar to FIG. 5 showing the position shown in FIG. 4;

FIG. 7 is a view similar to FIG. 5 showing the position shown in FIG. 3;

FIG. 8 is a perspective view of the rear of the device in the position shown in FIGS. 3 and 7; and

FIG. 9 is a perspective view of the case in the FIG. 8 configuration demonstrating use of the handle.

### DETAILED DESCRIPTION

The description below relates to the case as a whole. Most of the features of the invention, with the exception of the handle are features of the cover. The cover could therefore be sold as a separate item either for attachment to a bespoke body having the handle, or for attachment to a conventional body in which the case the functionality in relation to the handle would not be provided.

The case comprises a body 1 and a cover 2.

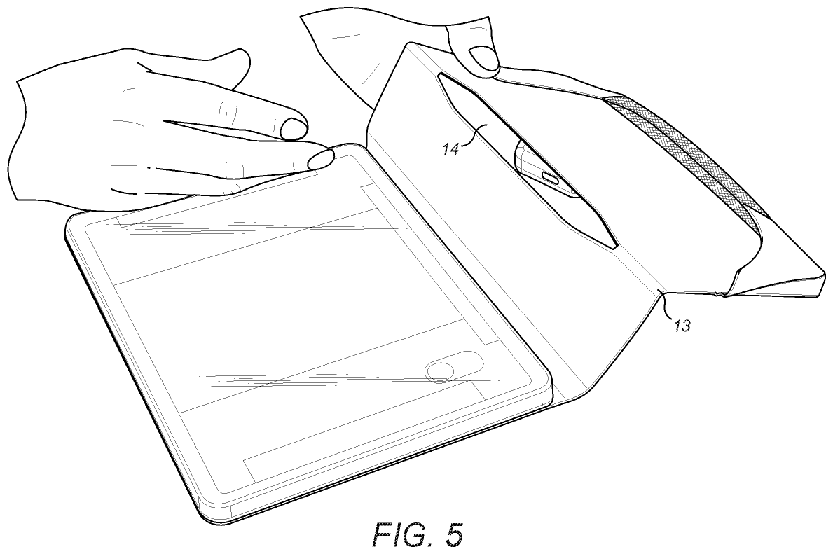

The body 1 has a generally conventional configuration having a shallow tray like structure with a rear wall 3 and side walls 4 and an open front face allowing access to the screen of the mobile device as can be seen from FIG. 5.

The rear wall 3 and side walls 4 are provided with the conventional openings for external devices such as headphone jacks, speakers, charging cable and cameras.

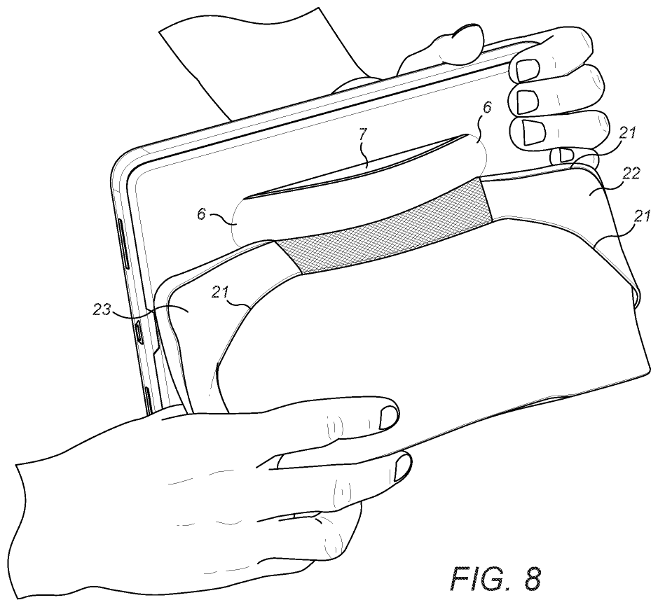

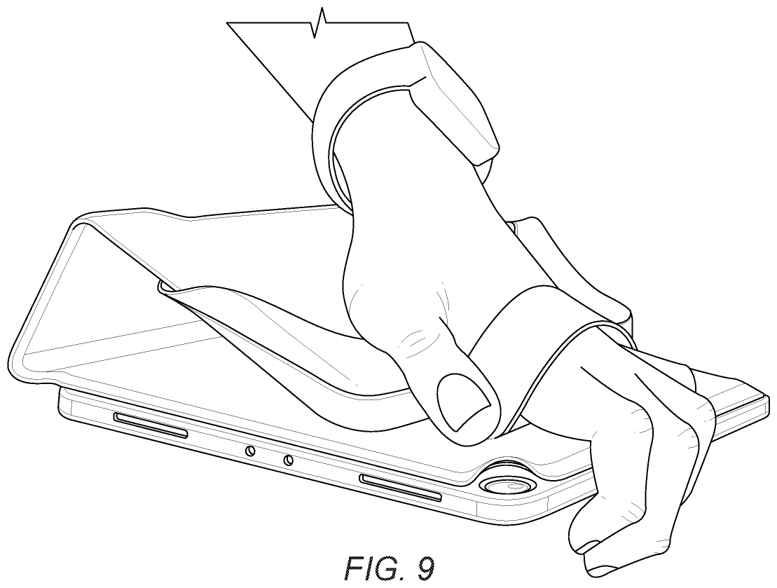

Rear wall 3 of the body 1 is provided with a handle 5 in the form of a flat strip of material which is retained in a pair of slots 6 at the ends of a recess 7 which is the same width as the handle. In a stored configuration, the handle 5 can be stored within the recess 7 so as to project beyond the rear wall 3. When needed, the handle 5 be pulled outwardly causing the ends of the handle 5 to slide out of the slots 6 into the deployed configuration shown in FIGS. 8 and 9 where it can be held as shown in FIG. 9 which is convenient for viewing the screen and/or demonstrating the screen to other people.

The features of the cover 2 will now be described.

The cover 3 is made up of three main components namely an inner layer 10 of a relatively rigid material, an outer layer 11 of an elastic material and a closure feature 12.

The inner layer 10 is a relatively rigid layer, while the outer layer 11 is made of an elastic material. The inner layer is a traditional laminated construction of PC, PLA or glass fibre sandwiched between heat-bonded PU sheets.

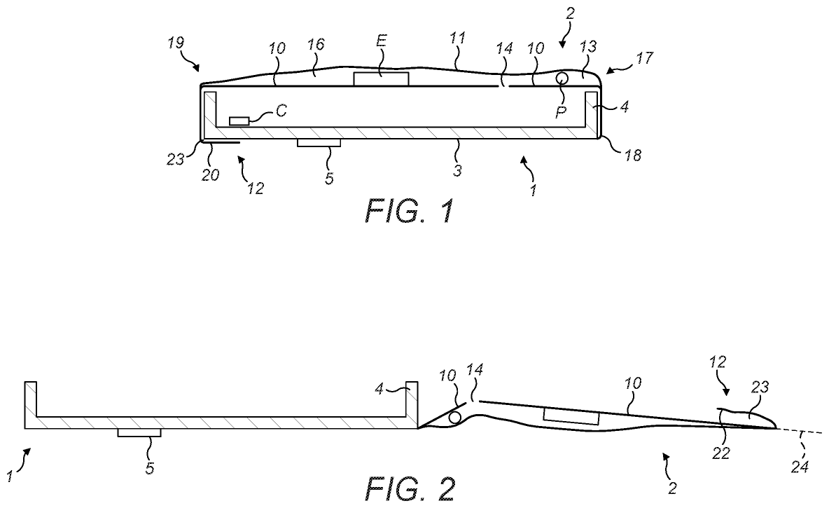

If the inner 10 and outer 11 layers extend across the full face of the cover. The layers are not attached to one another other than at their peripheral edges. It is possible, however, that the outer layer 11 does not fully extend across the whole face of the cover. The inner layer 10 is provided with fold line 13 as best shown in FIG. 5. In the central region of this fold line 13 is slit 14 which, as shown FIGS. 1 and 5 provides access to the space between inner 10 and outer 11 layers is creating a first pocket 15 and a second pocket 16. Because the slit 14 is closer to a first edge 17 adjacent to a hinge point 18 than to a second opposite edge 19, the first pocket 15 is narrower than the second pocket 16. As shown in FIG. 1, the first pocket 15 is ideal for an electronic pencil P while the second pocket 16 is shown containing a broader item, in this case wireless earphones E.

When no items are present, the elastic nature of the outer layer 11 ensures that it lies generally flat against the inner layer 10 thereby maintaining the lower profile of the case. When the items P and E are present, any bulging which occurs is primarily the outer layer 11, rather than the inner layer 10 such that the internal space within the case remains largely undisturbed by the presence of the items. Further the outer layer 11 curves relatively gently thereby providing a smooth outer surface to the case which is devoid of abrupt bulges.

At the second edge 19 of the cover 2 and on the opposite side of the outer layer 11 is the closure feature 12. This takes the form of flap 20 of elastic material which extends across the full length of the case in this region as best shown in FIG. 8. The flap of material is attached to the underlying layer along lines 21 at the periphery of the case, but is unattached its inward edge 22 in order to create a pocket 23 extending across the full length of the cover. As will be appreciated from FIG. 8, the pocket 23 is deeper in the regions of the corners than it is across the central region.

In use, when the cover is closed, the elasticated pocket 23 is stretched over the side wall 4 of the body 1 adjacent to the second edge 19 and holds the cover firmly in place. As can be seen from FIG. 1, the presence of the flap 20 in this region provides additional protection for this edge of the body 1. Further the flap 20 covers a camera (depicted schematically by C in FIG. 1) which is generally present at this position in the tablet when placed in the body 1.

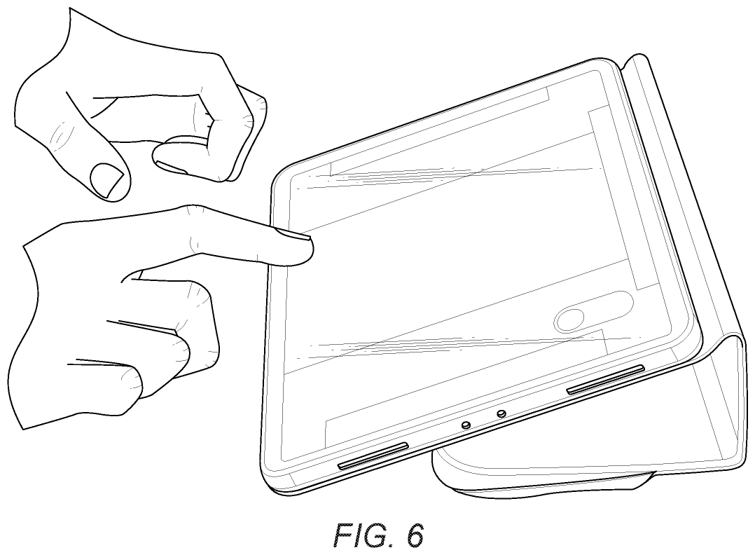

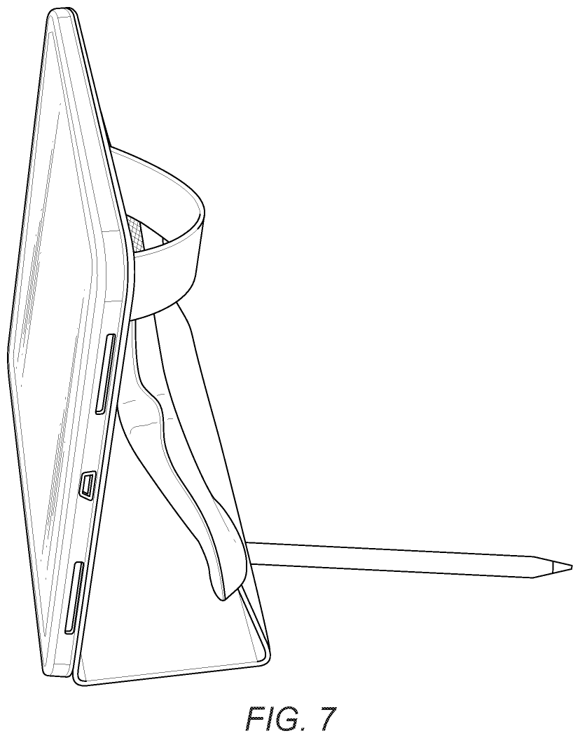

As shown in FIGS. 4, 6 and 7, the cover can be folded back to support the device in different orientations.

A central position of the second edge 19 of the cover 2 has a central tab (depicted schematically as 24 in FIG. 2) arranged to engage with the handle 5 in order to secure the cover in this position.

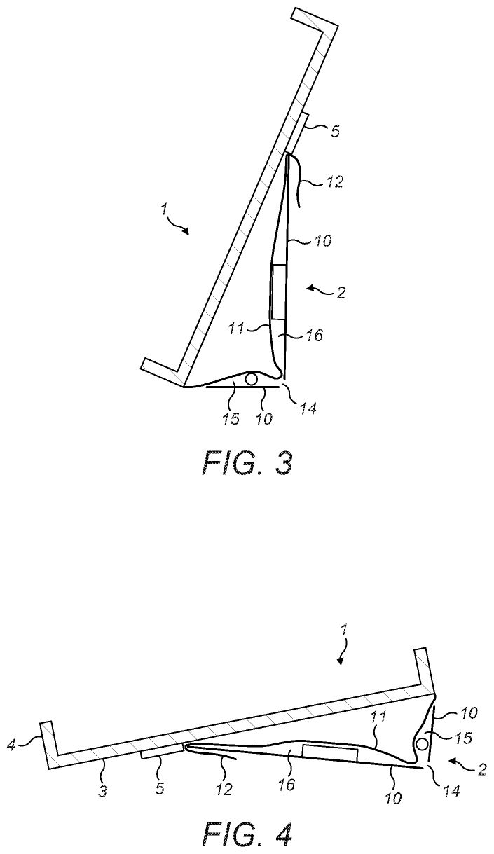

As can be appreciated from FIGS. 3 and 4, even if items are present at the pocket 15, 16, the cover can be readily supported in these positions as the majority of the bulging is accommodated by the outer layer 11 deflecting into the space between the cover 2 and the rear of the body, leaving the outer layer 10 relatively and therefore able still to provide stable support for the case in these positions.

1. A cover for a mobile device with a screen, the cover being configured to be pivotally connected a first edge to a body of a case having a generally rectangular shape and configured to receive the mobile device;
the cover having a second free edge opposite to the first edge, the cover being positioned in a closed position in which it substantially overlies the body to cover the device, in use;
the cover having an inner face facing the body in the closed position and an outer face opposite to inner face;
the cover having an inner layer of a first generally rigid material towards the inner face and an outer layer of an elastic material;
the cover having a fold line parallel to the first and second edges and closer to the first edge than the second edge, the cover being foldable about the fold line so as to be manipulatable into a number of configurations; and
a slit being formed in the inner layer in the vicinity of the fold line, the inner and outer layer being detached from one another in the vicinity of the slit so as to form a first pocket positioned on one side of the slit and between the inner and outer layers.

2. The cover according to claim 1, further comprising a second pocket positioned on the opposite side of the slit between the inner and outer layers.

3. The cover according to claim 1, wherein the layer of elastic material extends across the corners of the inner layer adjacent to the second edge so as to form corner pockets positioned, in use, to engage with corresponding corners of the body to hold the cover in the closed position

4. The cover according to claim 3, wherein the layer of elastic material extends across the full length of the second edge.

5. The cover according to claim 4, wherein the layer of elastic material is wider in the vicinity of the corners than it is in the area between the corners.

6. The cover according to claim 1, wherein the handle is formed of a flat strip of material retained at either end in slots in a rear face of the body opposite to and facing away from the cover, the handle being movable for a stowed position in which it lies flat against the rear face of the body to a deployed position in which its ends are moved closer together such that it takes up a bowed configuration providing a usable handle, the second edge of the cover having a projection to engage, in use, with handle in the deployed position.

7. A cover for a mobile device with a screen, the cover being configured to be pivotally connected a first edge to a body of a case having a generally rectangular shape and configured to receive the mobile device; and
the cover having a second free edge opposite to the first edge, the cover being positioned in a closed position in which it substantially overlies the body to cover the device, in use;
wherein a layer of elastic material extends across the corners of the inner layer adjacent to the second edge so as to form corner pockets positioned, in use, to engage with corresponding corners of the body to hold the cover in the closed position.

8. The cover according to claim 7, wherein the layer of elastic material extends across the full length of the second edge.

9. The cover according to claim 8, wherein the layer of elastic material is wider in the vicinity of the corners than it is in the area between the corners.

10. The cover according to claim 9, wherein a handle is formed of a flat strip of material retained at either end in slots in a rear face of the body opposite to and facing away from the cover, the handle being movable for a stowed position in which it lies flat against the rear face of the body to a deployed position in which its ends are moved closer together such that it takes up a bowed configuration providing a usable handle, the second edge of the cover having a projection to engage, in use, with handle in the deployed position.

11. A case comprising a body having a generally rectangular shape and configured to receive the mobile device and a cover according to claim 1 being pivotally connected at a first edge to the body.

12. A case comprising a body having a generally rectangular shape and configured to receive the mobile device and cover for a mobile device with a screen, the cover being configured to be pivotally connected a first edge to a body of a case having a generally rectangular shape and configured to receive the mobile device, the cover having a second free edge opposite to the first edge, the cover being positioned in a closed position in which it substantially overlies the body to cover the device, in use;
further comprising a handle formed of a flat strip of material retained by a rear face of the body opposite to and facing away from the cover, the second edge of the cover having a projection to engage, in use, with handle in the deployed position.

13. The case according to claim 12, wherein the flat slit of material forming the handle is retractable into the rear face of the body.

14. The case according to claim 13, wherein the handle is retractable at either end in slots;
the handle being movable from a stowed position in which it lies flat against the rear face of the body to a deployed position in which its ends are moved closer together such that it takes up a bowed configuration providing a usable handle.

15. The cover according to claim 1, wherein the cover has a length of greater than 19 cm and a width of greater than 13 cm.

16. The case according to claim 11, wherein the cover has a length of greater than 19 cm and a width of greater than 13 cm.

17. The case according to claim 14, wherein the cover has a length of greater than 19 cm and a width of greater than 13 cm.

18. The cover according to claim 1, wherein the cover has a length of greater than 23 cm and a width of greater than 16 cm.

19. The case according to claim 11, wherein the cover has a length of greater than 23 cm and a width of greater than 16 cm.

20. The case according to claim 14, wherein the cover has a length of greater than 19 cm and a width of greater than 13 cm.
